(19) United States
(12) Patent Application Publication
(10) Pub. No.: US 2008/0092700 A1
(43) Pub. Date: Apr. 24, 2008

(54) HANDLE DEVICE

(76) Inventors: Gerhard Meixner, Filderstadt (DE); Uwe Engelfried, Ostfildern (DE)

Correspondence Address: MICHAEL J. STRIKER, 103 EAST NECK ROAD, HUNTINGTON, NY, 11743, US

(21) Appl. No.: 11/874,699

(22) Filed: Oct. 18, 2007

(30) Foreign Application Priority Data
Oct. 23, 2006 (DE) 102006049827.5

(51) Int. Cl. B25G 1/00

(52) U.S. Cl. 81/489; 16/110.1

(57) ABSTRACT

A handle device, in particular a D-shaped handle has a handle region. The handle region in at least one subregion has at least one protuberance that subdivides the handle region into at least two grip regions

### CROSS-REFERENCE TO A RELATED APPLICATION

The invention described and claimed hereinbelow is also described in German Patent Application DE 102006049827.5 filed on Oct. 23, 2006. This German Patent Application, whose subject matter is incorporated here by reference, provides the basis for a claim of priority of invention under 35 U.S.C. 119(a)-(d).

### BACKGROUND OF THE INVENTION

The present invention relates in general to a handle device.

A handle device, in particular a D-shaped handle, that has a handle region is already known.

### SUMMARY OF THE INVENTION

The invention is based on a handle device, in particular a D-shaped handle, having a handle region.

It is proposed that the handle region in at least one subregion has at least one protuberance that divides the handle region into at least two grip regions; as a result, additional storage space, particularly for further units located inside the handle device, can be attained in a structurally simple way. Moreover, the two grip regions are as a result embodied with a thinner cross-sectional area, with the advantage that the two grip regions for a user of the power tool are more ergonomic, for instance being easier and more comfortable to grasp, and thus greater user comfort, are attainable. In this connection, the term “handle region” should be understood in particular to mean a region of the handle or of the handle device that is intended for one or both hands of a user to rest on and in particular grasp, especially during operation of a power tool using the handle device.

Advantageously, each of the two grip regions is intended for one hand of a user to rest on and in particular grasp, so that by means of the two grip regions, comfortable and in particular two-handed operation of a power tool with a handle device of this generic type is made possible for a user. In addition, within the handle region, solely the grip regions are intended for a hand of the user to rest on or grasp, while in contrast to the grip regions, the protuberance has solely a dividing function or receiving function within the handle region. The protuberance may rise in the manner of an extension from the handle region or especially advantageously can form a smooth transition with the two grip regions. Especially advantageously, the handle device is intended for a power tool with a rotating and/or hammering drive for a tool, such as a drill hammer, chisel hammer, percussion hammer, and so forth.

It is also proposed that the subregion having the protuberance is formed by a middle subregion along a main lengthwise direction of the handle region; as a result, an especially advantageous division of the handle region into two grip regions can be attained. The term “middle subregion” should be understood here to mean in particular a region of the handle region that subdivides the handle region into two grip regions, preferably of equal size. Advantageously, the two grip regions make it possible for a user to operate a power tool with the handle device using both hands.

In an advantageous refinement of the invention, it is proposed that the protuberance has a receptacle means, which is intended to receive at least one further unit, and as a result a compact handle device can be attained. Preferably, the receptacle means is embodied integrally with the protuberance, so that additional components, space, assembly effort, and expense can advantageously be saved. In this connection, the term “further unit” should be understood in particular to mean one or more mechanical and/or electrical and/or electronic units and so forth, such as a damping unit and/or especially advantageously an actuation switch for operating the power tool and/or further units that appear appropriate to one skilled in the art.

Especially advantageous protection and a secure location of the further units can be attained if the receptacle means is located inside the protuberance.

It is also proposed that the protuberance has a protuberance direction, which extends along an axis that extends parallel to a coupling direction, and as a result, an especially advantageous bracing of one hand of a user is attained, while unwanted slipping of his hand can advantageously be prevented. The term “coupling direction” should be understood to mean a direction of a handle device with which the handle device can be coupled, beginning at the handle region of the handle device, to a power tool and which corresponds to a direction of force transmission by a user from the handle device to the power tool during operation of the power tool. The term “protuberance direction” should be understood in this connection to mean in particular a direction that is advantageously oriented perpendicular to a face of the handle region and with which the protuberance rises outward in a radial direction from the face of the handle region or the two grip regions. The protuberance may be located on a side of the handle region that faces toward the power tool and/or away from the power tool.

Advantageous bracing of one hand of a user can moreover be attained and unwanted slipping of his hand can be advantageously avoided if the protuberance has a protuberance direction, which extends along an axis that extends perpendicular to a coupling direction. The protuberance may be located on a left and/or right outer face of the handle region, in terms of the actuation direction of the handle device. Especially advantageously, the protuberance may be located annularly around the handle region in the circumferential direction of the handle region.

In a further advantageous feature of the invention, it is proposed that the protuberance is embodied integrally with the grip regions of the handle region, as a result of which further components, space, assembly effort, and expense can advantageously be saved. Especially advantageously, this can be achieved if the protuberance and the grip regions of the handle region are formed from an identical material.

Moreover, a power tool with a handle device is proposed, in which the handle device is formed by a main handle. Especially robust, stable handling of the power tool for a user can then be achieved. In particular, an advantageous transmission of force by means of the handle device from the user to the power tool can be attained.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a power tool with a handle device of the invention in a schematic side view; and

FIG. 2 shows the power tool with the handle device of FIG. 1 in a schematic view from the back.

### DESCRIPTION OF THE PREFERRED EMBODIMENTS

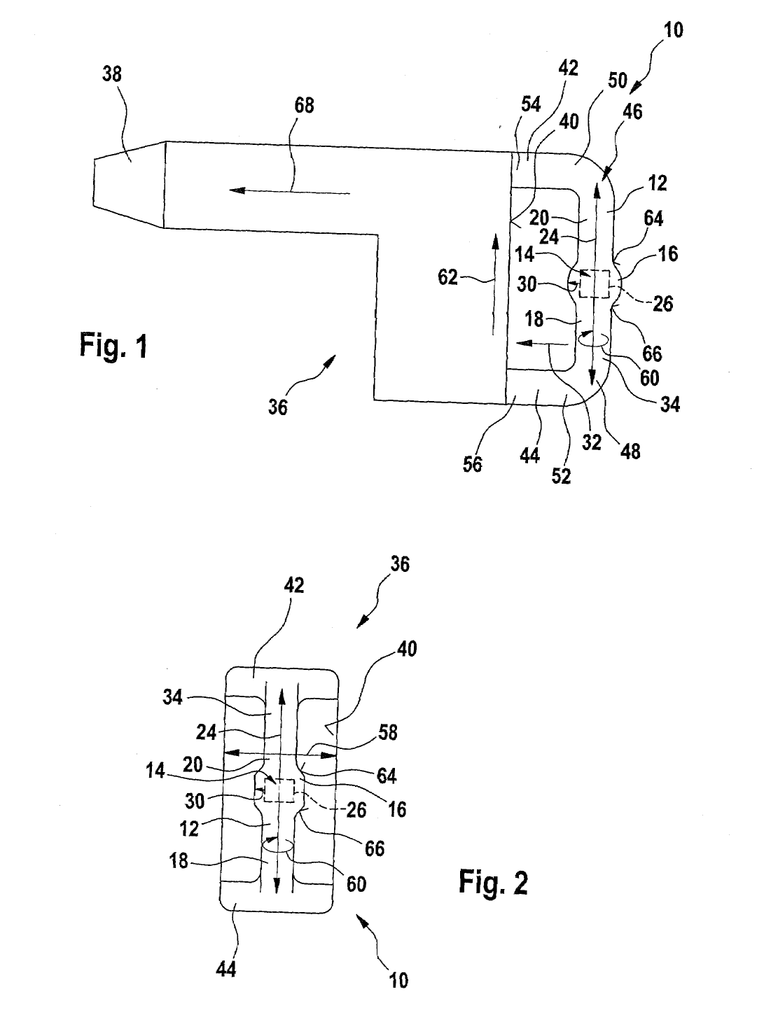

In FIGS. 1 and 2, a power tool 36 is shown, with a handle device 10 of the invention and with a rotating and/or hammering drive, not shown in detail here, for a tool receptacle 38, or for a tool located in the tool receptacle 38. The handle device 10 is formed by a main handle 34 of the power tool 36 and is located on a side 40 of the power tool 36 facing away from the tool receptacle 38.

The handle device 10 formed by a D-shaped handle has a handle region 12 and two handle subregions 42, 44, which are oriented perpendicular to a main lengthwise direction 24 of the handle region 12 and parallel to one another. The two handle subregions 42, 44 each adjoin a respective peripheral region 46, 48 of the handle region 12 and are located between the handle region 12 and the power tool 36. The two handle subregions 42, 44 furthermore, each on a respective side 50, 52 oriented toward the handle region 12, have a smaller cross-sectional area, adapted to the handle region 12, than a cross-sectional area on a side 54, 56, facing toward the power tool 36, that is adapted to a width 58 of the power tool 36.

The handle region 12, or in other words the main lengthwise direction 24 of the handle region 12, is located parallel to a main handle 62 of the side 40, facing away from the tool receptacle 38, of the power tool 36 (FIG. 1). The handle region 12, or the main lengthwise direction 24 of the handle region 12, is furthermore oriented perpendicular to a coupling direction 32 of the power tool 36; beginning at the handle region 12, the coupling direction 32 extends in the direction of the power tool 36. The coupling direction 32 is furthermore oriented parallel to an actuation direction 68 of the power tool 36, which extends from the side 40, facing away from the tool receptacle 38, of the power tool 36 in the direction of the tool receptacle 38.

The handle region 12, in a subregion 14, has an annular protuberance 16, which subdivides the handle region 12 into two grip regions 18, 20. The subregion 14 with the annular protuberance 16 is formed by a middle subregion 14 along the main lengthwise direction 24 of the handle region 12 and is additionally embodied integrally with the handle region 12. In addition, the annular protuberance 16 and the handle region 12, or the two grip regions 18, 20, are formed of an identical material. By means of the annular protuberance 16 in the middle subregion 14 of the handle region 12, the two grip regions 18, 20 are virtually the same length along the main lengthwise direction 24 of the handle region 12 and make it possible for a user of the power tool 36 to rest one hand on each of the two grip regions 18, 20, or to grasp each of the two grip regions 18, 20 with one hand.

The annular protuberance 16 is located on the handle region 12, in a circumferential directions 60 perpendicular to the main lengthwise direction 24 of the handle region, and extends from the handle region 12 with a protuberance direction 30. The protuberance direction 30 of the annular protuberance 16 extends from the handle region 12, or the two grip regions 18, 20, radially outward in the circumferential direction 60 of the handle region 12. In addition, the annular protuberance 16 is spaced apart, in a direction of the power tool 36 or of the side 40 facing away from the tool receptacle 38, on the handle region 12 of the power tool 36.

The annular protuberance 16 merges with the two grip regions 18, 20 by means of respective transition faces 64, 66, each of which has a surface that is curved outward in concave fashion. In a further embodiment of the invention, not shown in FIGS. 1 and 2, however, it is also conceivable for the protuberance 16 to be limited to one side, or to two diametrically opposed sides, of one surface of the handle region 12. The protuberance 16 may be limited to a subregion 14 or distributed over two subregions 14, which region or regions extend along an axis that extends parallel or perpendicular to the coupling direction 32, in the middle subregion 14 of the handle region.

In principle, it is also conceivable at any time to locate the protuberance 16 on the handle region 12 in some other way in a further embodiment of the invention that appears useful to one skilled in the art.

A receptacle means 26, formed by a reception region, is located inside the annular protuberance 16. The receptacle means 26 is intended for receiving further units of the handle device 10 or of the power tool 36, such as a mechanical, pneumatic, electrical and/or electronic damping unit and/or an on-off switch for the power tool 36 and/or further units that appear useful to one skilled in the art.

It will be understood that each of the elements described above, or two or more together, may also find a useful application in other types of constructions differing from the type described above.

While the invention has been illustrated and described as embodied in a handle device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A handle device, comprising a handle region, said handle region in at least one subregion having at least one protuberance that subdivides said handle region into at least two grip regions.

2. A handle device as defined in claim 2, wherein said subregion having said protuberance is formed as a middle subregion along a main lengthwise direction of said handle region.

3. A handle device as defined in claim 1, wherein said protuberance has a receptacle means configured for receiving at least one further unit.

4. A handle device as defined in claim 3, wherein said receptacle means of said protuberance is located inside said protuberance.

5. A handle device as defined in claim 1, wherein said protuberance has a protuberance direction which extends along an axis that extends parallel to a coupling direction.

6. A handle device as defined in claim 1, wherein said protuberance has a protuberance direction which extends along an axis that extends perpendicular to a coupling direction.

7. A handle device as defined in claim 1, wherein said protuberance is configured integrally with said at least two grip regions of said handle region.

8. A handle device as defined in claim 1, wherein said protuberance and said at least two grip regions of said handle region are composed of an identical material.

9. A handle device as defined in claim 1, wherein said handle device is configured as a D-shaped handle.

10. A power tool, comprising a handle device including a handle region, said handle region in at least one subregion having at least one protuberance that subdivides said handle region into at least two grip regions.

11. A power tool as defined in claim 10, wherein said handle device is configured as a main handle.
